(19) United States
(12) Patent Application Publication
(10) Pub. No.: US 2014/0057600 A1
(43) Pub. Date: Feb. 27, 2014

(54) Virtual SIM

(71) Applicant: VIET PHU PAYMENT SERVICES SUPPORT CORPORATION, Ho Chi Minh (VN)

(72) Inventor: Trung Dung, Ho Chi Minh (VN)

(73) Assignee: VIET PHU PAYMENT SERVICES SUPPORT CORPORATION, Ho Chi Minh (VN)

(21) Appl. No.: 13/973,994

(22) Filed: Aug. 22, 2013

Related U.S. Application Data
(60) Provisional application No. 61/692,221, filed on Aug. 22, 2012.

(51) Int. Cl. H04W 8/02; H04B 1/38

(52) U.S. Cl. CPC H04W 8/02; H04B 1/3816
USPC 455/411; 455/558; 455/432.1; 455/417

(57) ABSTRACT

A virtual SIM can be used in conjunction with a physical SIM to minimizing roaming charges. A mobile device can sign up with a primary telephone company to have a physical SIM and a primary telephone number. The mobile device can also sign up with a service provider that can have telephone partners in foreign countries. The foreign telephone partners can provide local coverage through a virtual SIM and the primary telephone number from the physical SIM.

The present application claims priority from provisional patent application Ser. No. 61/692,221, filed on Aug. 22, 2012, which is hereby incorporated by reference.

### BACKGROUND OF THE INVENTION

The present invention relates to communication or telecommunication.

Mobile phones can use a number of technologies and formats, such as GSM (Global System for Mobile Communication), CDMA (Code Division Multiple Access) and/or UMTS (Universal Mobile Telecommunications System) technology. To store data, GSM and UMTS mobile phones can use the Subscriber Identity Module (SIM), commonly known as a SIM card. The SIM card can be a detachable card, which can contain the user's provisioning or subscription information and other information. The SIM card can allow the user to change telephone network companies by changing the SIM card while keeping the mobile phones.

The SIM cards can store network specific information used to authenticate and identify subscribers on the network, such as the ICCID, IMSI, Authentication Key (Ki), and Local Area Identity (LAI). For example, a Local Area Identification (LAI) can be downloaded to the SIM card via the cellular infrastructure to identify the location for the network. The SIM cards can also store other carrier specific data such as the SMSC (Short Message Service Centre) number, Service Provider Name (SPN), Service Dialing Numbers (SDN), and Value Added Service (VAS) applications.

FIG. 1 illustrates a prior art mobile phone. A mobile phone 110, through a physical SIM 115, can communicate with a home telephone network 120 in a home country 101. The communication can be a voice call, a text message, or any other forms of telecommunication. The physical SIM establishes connection with the telephone network, for example, through a prepaid plan, a monthly plan, or a pay-per-call plan. When the mobile phone 110 is in a foreign country 102, the physical SIM 115 can establish communication with a foreign telephone network 125. The foreign telephone network 125 can be a part of the home telephone network 120, or a partner of the home telephone network 120. The mobile communication in the foreign country 102 is often called roaming, and can incur great expense.

SIM card technology can be expensive. For example, international travelers can be charged with high fees for international roaming calls or text messages. An option is to buy a local phone/service, or to buy local SIM cards.

### SUMMARY OF THE EMBODIMENTS

In some embodiments, provided are methods, and a virtual SIM and a mobile device, for mobile communication with minimum or without roaming charges. The methods includes using a physical SIM for home country telecommunication usage, and a virtual SIM for foreign country telecommunication usage. In both cases, the mobile device can have local connection without roaming charges. Further, the telephone number from the physical SIM is used, thus allowing the mobile device to have a single telephone number during all communication.

### BRIEF DESCRIPTION OF THE DRAWINGS

FIG. 1 illustrates a prior art mobile phone.

FIG. 2 illustrates a virtual SIM according to some embodiments.

FIG. 3 illustrates a flowchart for a mobile device having a virtual SIM according to some embodiments.

FIG. 4 illustrates a communication process utilizing a virtual SIM in additional to a physical SIM according to some embodiments.

FIG. 5 illustrates a flow chart for a virtual SIM service according to some embodiments of the present invention.

FIG. 6 illustrates communication paths originated from a physical SIM according to some embodiments.

FIG. 7 illustrates a process for connecting a mobile phone to a recipient through a physical SIM according to some embodiments.

FIG. 8 illustrates a configuration for communication transmission to a virtual SIM/physical SIM combination in a home country according to some embodiments.

FIG. 9 illustrates a configuration for communication transmission to a virtual SIM/physical SIM combination in a foreign country according to some embodiments.

FIG. 10 illustrates a process for connecting a mobile phone to a recipient through a service provider according to some embodiments.

FIG. 11 illustrates a configuration for communication transmission to a virtual SIM/physical SIM combination in a foreign country according to some embodiments.

FIG. 12 illustrates a process for connecting a mobile phone to a recipient through a foreign telephone company according to some embodiments.

FIG. 13 illustrates another configuration for communication transmission to a virtual SIM according to some embodiments of the present invention.

FIG. 14 illustrates another process for connecting a mobile phone to a recipient according to some embodiments.

FIG. 15 illustrates a process for a service provider according to some embodiments.

FIG. 16 illustrates a process for a foreign telephone company to establish a connection with a virtual SIM according to some embodiments.

FIG. 17 illustrates a computing environment according to some embodiments.

FIG. 18 is a schematic block diagram of a sample computing environment 1800 with which the present invention can interact.

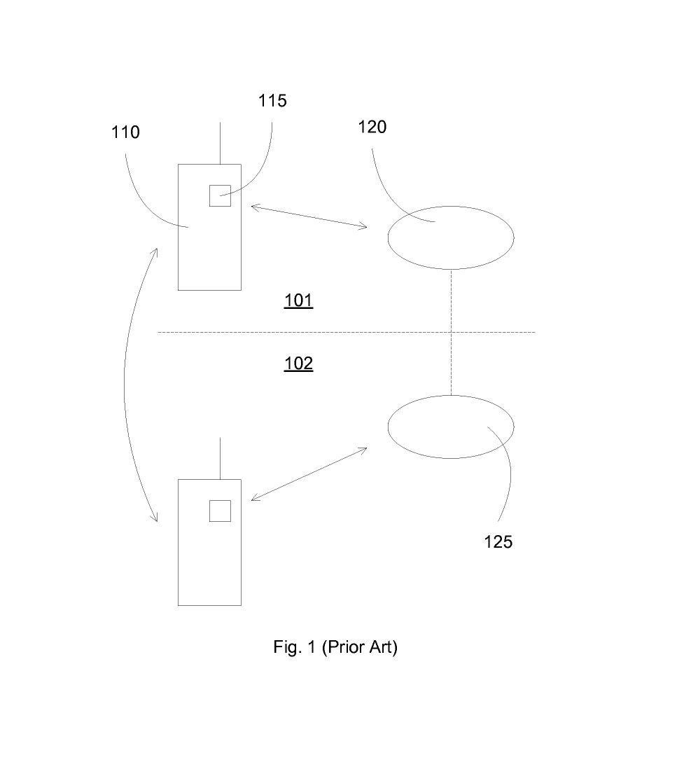

### DETAILED DESCRIPTION OF THE EMBODIMENTS

In some embodiments, the present invention discloses methods and systems utilizing a virtual SIM, in connection with a physical SIM, for mobile communication. A virtual SIM can be installed in a mobile phone having a physical SIM, allowing the mobile phone to send and receive text message and voice communication without or with minimum roaming charges.

In the virtual SIM, internal memory can be used to store provisioning information of the mobile phone, e.g., from the physical SIM, allowing the mobile phone with the virtual SIM to access the cellular network. A mobile phone can include a physical SIM, together with communication components such as an antenna for communicating with a cellular network, and transmitting voice and data signals over the cellular telephone network to selected destinations. A virtual SIM can be coupled to an authentication server, for example, by incorporating authentication functions within the virtual SIM software. The mobile phone can include a processor and an internal memory storage unit, which can be configured to store network provisioning and personal data. Software encryption can be used to protect data from unauthorized viewing.

In some aspects, the virtual SIM can function as a physical SIM in mobile phones. For example, a mobile phone processor can recalls the network provisioning information to connect to the cellular telephone network. The virtual SIM can be provided with a mechanism for supporting conventionally cellular services, such as calling from various countries, wherein the virtual SIM card is enabled so that the user can dynamically load local SIM information by accessing a remote server and obtain local cellular services. In some aspects, the virtual SIM shares information with the physical SIM, for example, the virtual SIM utilizes the identification of the physical SIM, such as phone number, or international mobile subscriber identification (IMSI). Thus the virtual SIM can establish communication with a telephone network service using the credential, e.g., phone number, of the physical SIM.

In some embodiments, the present invention discloses a mobile communication device having a physical SIM and a virtual SIM. The physical SIM can provide coverage when the mobile device is within the network of the first telephone company issuing the physical SIM. When the user is out of the local coverage of the first telephone company, and within the local coverage of a second telephone company, the virtual SIM can provide local communication between the mobile device and the second telephone company. In addition, the virtual SIM uses the identification of the physical SIM, e.g., the telephone number, thus even when using the virtual SIM with the second telephone company, the user is represented as calling with the same identification of the physical SIM. An advantage of the virtual SIM is the avoidance of roaming charges (since the communication with the second telephone company is local), together with the ability to maintaining the same identification of the physical SIM, e.g., same phone number appearing as the caller-id in the recipient device.

In some embodiments, the present invention discloses a service provider to provide services to a mobile phone through a virtual SIM. The service provider can have multiple telephone companies as partners in different countries, which can provide mobile communication to the mobile phone around the world. For example, after signing up with the service provider, the mobile phone, through a virtual SIM, can have access to telephone networks, e.g., the telephone partners of the service provider, in different countries without incurring roaming surcharge.

In some embodiments, the virtual SIM can be a supplemental SIM for a mobile phone, in addition to a physical SIM or another virtual SIM. Most communication, or communication by default, can be performed through the physical SIM or the virtual SIM. The mobile communication expense can be calculated based on the actual usage of the mobile phone, or by a service contract. For example, the physical SIM can be used in the home country, and the virtual SIM can be used in specific countries, replacing the roaming charge performed through the physical SIM.

In some embodiments, the present invention discloses methods and systems for providing international communication at a local price. International communication is usually charged at a much higher price that local communication, for example, by the high roaming charge. A service provider can sign up with different telephone companies in different countries, which then can offer local charges to mobile phones that are within their network coverage. The mobile phones are no longer roaming, since they are within the local coverage of the telephone companies. The mobile phones can have virtual SIM, which can identify the mobile phones as local phones when located within a telephone network coverage.

In some embodiments, the present invention discloses a method to use a virtual SIM, a virtual SIM for used in a mobile device, and a mobile device that uses the virtual SIM.

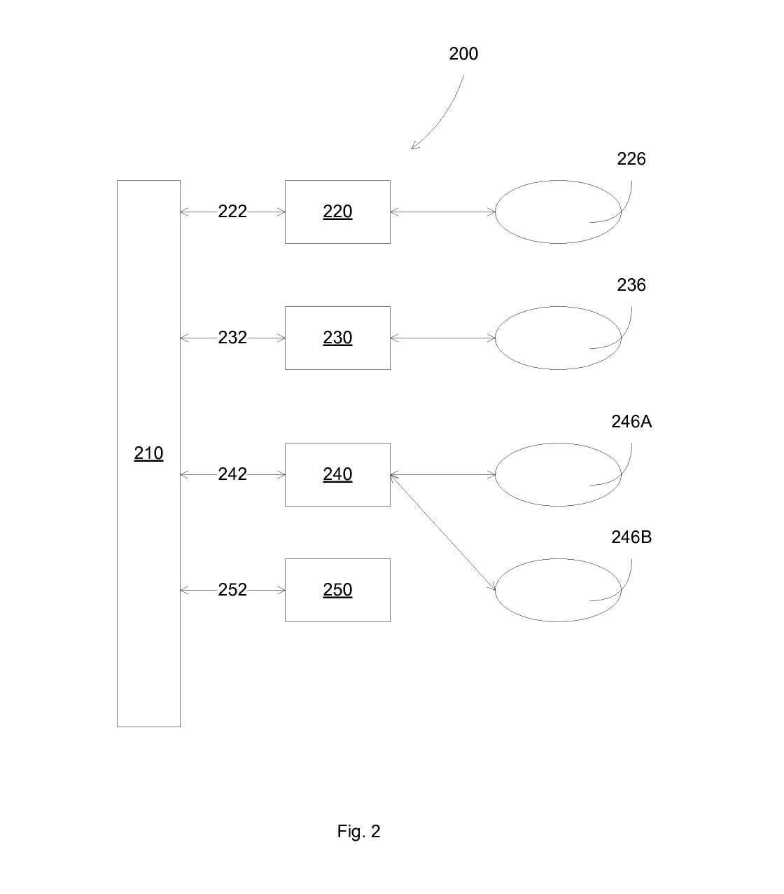

FIG. 2 illustrates a virtual SIM according to some embodiments. A virtual SIM 200 can include a controller 210, together with various modules 220, 230, 240, and 250, coupled to the controller 210 through buses 222, 232, 242, and 252, respectively. Other modules can also be included. Module 220 can be used for communicating with a first telephone company 226 through a physical SIM. The first telephone company can be a company that the mobile device is registered, e.g., the user of the mobile device can have a service agreement with the first telephone company. The first telephone company can provide the user with a physical SIM, which is installed in the mobile device for communication through the first telephone company. Module 220 of the virtual SIM can be configured to allow the mobile device to establish communication, e.g., sending or receiving text messages or telephone calls, through the first telephone company through the physical SIM. Module 220 can be configured to extract the identification of the physical SIM, such as the telephone number, or the IMSI. The identification of the physical SIM can be used for identify the mobile device when the virtual SIM is used, which can allow the mobile device to have the same identification using the virtual SIM or the physical SIM.

Module 230 of the virtual SIM 200 can be used for communicating with a service provider 236. For example, module 230 can be configured to accept a service contract with the service provider. The service provider can be a company that provides or facilitates the telecommunication service. For example, the service provider can be a telephone network company. The service provider can be a company that does not provide telephone communication, but can provide telecommunication such as between computers or between computers and telephones. The service company can be a company that brokers telecommunication service, e.g., buying services from telephone company and re-sell to consumers. Module 230 can be configured to allow the mobile device to establish connection and communication with the service provider, together with other users of the service provider. For example, module 230 can include a software program that allows the mobile device to be connected to an internet portal of the service provider, or to be connected to other users of the service provider through the internet.

In some embodiments, module 230 can be configured to accept a forwarding telephone number. The forwarding telephone number can be used to identify the mobile device, for example, when the service provider wants to establish a connection with the mobile device. The forwarding telephone number can be a regular telephone number, or can be any identification tag, including alphanumeric or numeric formats. For example, when the service provider receives a communication from a recipient, wanting to establish a communication with the user. The service provider can use the forwarding number to locate the user and establish a connection between the user and the recipient.

Module 240 of the virtual SIM can be used for communicating with one or more second telephone companies 246A, 246B that have a service agreement with the service provider. Module 240 can be configured to enable communication with a second telephone company of the one or more second telephone companies using a mobile device identification of the physical SIM. For example, the mobile device can have telephone connectivity with a second telephone company through module 240. Module 240 can establish the connection using the identification or credential of the physical SIM, thus provide telephone connectivity within the second telephone company network while keeping the identity of the first telephone network. Thus a user, when using module 240 to communicate with a recipient through the second telephone network, can sending the telephone number from the physical SIM, e.g., the telephone number that the mobile device always has from the first telephone company. The connection with the second telephone company can be a local connection, e.g., when the mobile device is within the service coverage of the second telephone company. For example, when the user visits a foreign country, the second telephone company can be a telephone company from the foreign country, and thus all calls to the second telephone company are local calls, without roaming charges.

In some aspects, module 240 can be similar to the case that the user purchases a new SIM card from the second telephone company to use in the mobile device. All calls from the mobile device can be routed through the second telephone company, and are considered local calls. However, the new SIM can have a new number, local to the second telephone company. Thus a recipient of the call would not recognize the caller. In contrast, a significant benefit and distinction is that module 240 of the virtual SIM 200 can provide the telephone number from the physical SIM, thus allowing the recipients of the mobile device to recognize the calls as originated from the user.

Module 250 of the virtual SIM can be used for assessing a connectivity of the mobile communication device with the first or the one or more second telephone companies. For example, module 250 can be configured to identify a location of the mobile communication device. Module 250 can be used to query the telephone service companies to see if the mobile device is within range, which can establish the location of the mobile device. The location of the mobile device can be used to forward a communication of a recipient, which is received by the service provider. For example, the mobile device can be set up so that communication to the mobile device is routed to the service provider. When the service provider receives a communication intended for the mobile device, the service provider then assess a connectivity of the mobile device with the first telephone company, e.g., whether or not the mobile device is within range of the first telephone company. If it is, the communication is already sent to the mobile device by the first telephone company, and the service provider does not need to do anything.

If it is not, e.g., the mobile device is out of the range of the first telephone company, and can be in a foreign country, such as a country serviced by a second telephone company partner of the service provider. The service provider can use module 250 to query the connectivity of the mobile device. For example, a second telephone company can be identify as hosting the mobile device, e.g., the mobile device is recognized and provided serviced by the second telephone company. The service provider can then forward the communication to the second telephone company, so that the second telephone company can send the communication to the mobile device. The forwarding service can be performed through a forwarding number that the mobile device has registered with the service provider, as in the case of module 230.

In the context of the present invention, the term “mobile phone” or “mobile device” or “mobile communication device” includes a movable device that can used to communicate, such as any type of wireless device, mobile station, or portable computing device with a self-contained power source (e.g., battery) such as a laptop computer, tablet computer, personal digital assistant (PDA), cellular telephone, mobile unit, subscriber station, user terminal, portable computer, handheld computer, palmtop computer, wearable computer, media player, pager, messaging device, data communication device, and game device. The mobile phone can include a phone application, one or more message applications (e.g., telephone, voicemail, facsimile, e-mail, IM, SMS, MMS, video conferencing), and a web browser application.

In some embodiments, the virtual SIM can be used in conjunction with other SIM, such as a physical SIM or another virtual SIM. The physical SIM can be the major communication device (e.g., in the home country where the mobile device is registered), and the virtual SIM can be a supplemental communication device (e.g., in foreign countries to have local communication instead of roaming service if using the physical SIM). For example, a physical SIM can be the default communication mode when the mobile phone is within the telephone coverage of a home country. When the mobile phone is abroad, e.g., outside the telephone coverage of the home country and within the telephone coverage of a foreign country, the virtual SIM can become the default communication mode, providing communication through the virtual SIM to a service provider and its partner telephone network company. Significant saving can be achieved, since high roaming charge can be avoided. For example, a user can shop for a suitable home country coverage, without concerning about the high roaming coverage. The international coverage can be selected based on the service provider, which can offer international coverage at a local price.

In some embodiments, a user can install a virtual SIM, e.g., a mobile social application, on a mobile phone, such as an iPhone or an Android. The virtual SIM can be integrated with a telephone company. In some embodiments, the telephone company can be the third or fourth telephone company in each country. The mobile phone can have a physical SIM with any telephone company.

In some embodiments, the mobile phone can have GPRS (general packet radio service) connection, 2G, 3G, or 4G (generation of mobile telecommunication), or wifi connection. The virtual SIM can allow the mobile phone to communicate, e.g., chat, message, and voice, with other people in the same community or in different community, including other mobile phones and land phones.

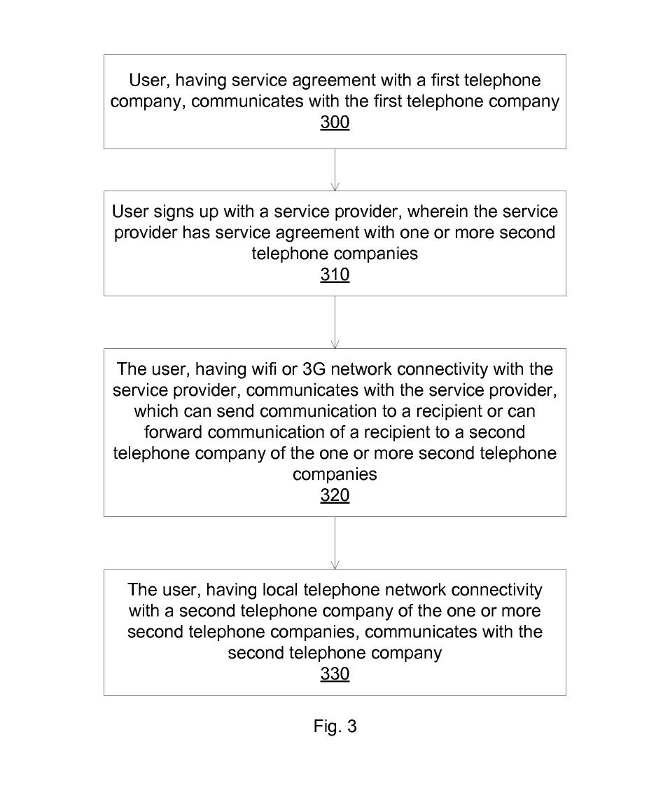

FIG. 3 illustrates a flowchart for a mobile device having a virtual SIM according to some embodiments. The mobile device can always have a same identification, e.g., a same telephone number regardless of the telephone companies that provide the communication. The mobile device can always achieve local calls, regardless of locations, e.g., either in a home country or in a foreign country. The mobile device can also have wifi connectivity, with low or no cost in communication services.

In operation 300, a user can have a service agreement with a first telephone company. The first telephone company can provide a physical SIM to be used in a mobile device. The physical SIM can be used to identify the mobile device, such as a telephone number. The mobile device can be used to communicate with other mobile devices through the first telephone company network. For example, if the other mobile device is registered with the same first telephone company, the first telephone company can connect the mobile device with the other mobile device. If the other mobile device is registered with another telephone company, the telephone company can establish connection with the another telephone company, thus connecting the mobile device with the other mobile device through the first and the another telephone companies. In the home country, e.g., the country or the area that the first telephone company provides service, the calls generated from the mobile device are local, without roaming charges. Outside the coverage area of the first telephone company, calls are no longer local, and can incur high roaming charges.

In some embodiments, the physical SIM can be used for calls within the service area of the first telephone company, allowing low cost communication, e.g., local calls without roaming charges.

In operation 310, the user signs up with a service provider. The service provider can have service agreement with one or more second telephone companies. The service agreement can allow the user to use the second telephone companies when the user is within their coverage range. The agreement can allow the user to have local connection with the second telephone companies when the user is within their coverage range. The second telephone companies can recognize the user presence, e.g., by the broadcasting of the mobile device when turned on in the coverage range of the second telephone companies. The mobile device can use the physical SIM to establish its identity. The second telephone companies can look up in the VLR (visitor location register) roaming database, and acquire authorization from the service provider, and/or the first telephone company, to provide service to the mobile device.

In operation 320, the user can have wifi or 3G network connectivity with the service provider. For example, the user can have communication with other users of the service provider, for example, through the internet without incurring telephone charges. The user can communicate with other mobile devices through the service provider portal. For example, the user can communicate with the service provider, which can forward the communication to a telephone company to send to the recipient. The first portion of the communication can be performed through the internet network. The second portion can be performed through the telephone network, e.g., 3G or 4G.

In operation 330, the user can have a local telephone network connectivity with a second telephone company that is a partner of the service provider. The user can communicate with the second telephone company and incur local charges instead of roaming charges, even though the user is outside of the home country.

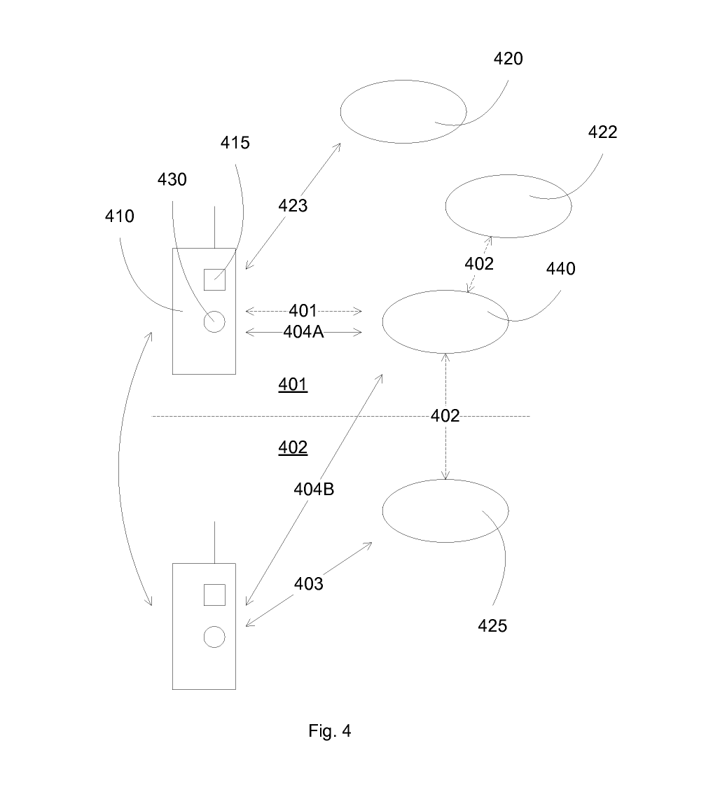

FIG. 4 illustrates a communication process utilizing a virtual SIM in additional to a physical SIM according to some embodiments. A mobile phone 410 can have a physical SIM 415 together with a virtual SIM 430. The mobile phone can include a physical SIM 415, which can communicate 423 with a telephone company 420 within a home country 401 with local communication charges.

In addition, the mobile phone can communicate 401 to have a service contract with a service provider 440. The service provider 440 can communicate 402 with telephone network companies 425 and 422, for example, to register the virtual SIM as a valid local communication client for these telephone companies when the mobile phone is within the range of service of these companies. For example, when the mobile phone is in foreign country 402, the mobile phone can be within the coverage of a telephone network company 425, which is a partner of the service provider 440. The telephone network company 425 can authenticate the mobile phone through the virtual SIM, and the mobile phone can use the telephone network 425 to perform communication services 403, such as sending or receiving voice calls or text messages. The service cost can be a local service cost, since the mobile phone appears to the telephone company 425 as a local client. For example, to the telephone company 425, the mobile phone 410 can be a local client, with all invoices and billings charged to the service provider 440.

In some embodiments, a user can install a virtual SIM on a mobile phone, and register for the virtual SIM service. The user can pre-buy certain amount of credits for the virtual SIM services. The user can configure a forwarding number, which is defined by the service provider, which offers the virtual SIM service. The virtual SIM service providers can store user IMSI, mobile phone number in its central database.

For each country, the service provider can sign up a partner telephone company, and can buy wholesales data, SMS, voice as well as a set of mobile numbers with each of the partner. The service provider can also set up a forwarding number, which will serve as a switch, used to forward calls to mobile phones in foreign countries. The service provider can register the virtual SIM information to the VLR database of its telephone company partner for each host country.

In some embodiments, the service provider 440 can be accessed by internet, and the mobile phone can use the service provider 440 for wifi service 404A and 404B, wither in home country 401 or in foreign country 402.

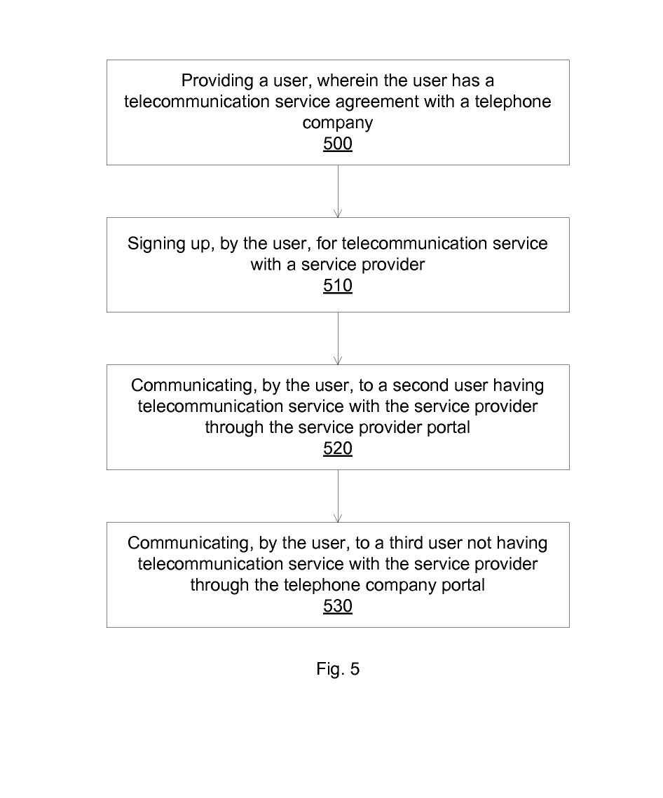

FIG. 5 illustrates a flow chart for a virtual SIM service according to some embodiments of the present invention. In operation 500, a user has a telecommunication service with a telephone company, for example, through a physical SIM. In operation 510, the user signs up with a service provider. For example, the user can have a service contract with the service provider that covers telecommunication in different countries. For example, the service provider can have partners in different countries, in which the partners can offer telecommunication in these countries. The service contract can specify the invoice and billing terms, such as monthly plan, pay-per-communication plan, or minute plan. The service provider can provide a virtual SIM to a mobile phone of the user. The virtual SIM can be recognized by a telephone company in each country that the user wishes to have telephone coverage when the user is within the network service of the telephone company. The user can avoid roaming charges, since the telephone company can treat the mobile phone as a local client, payable by the service provider. In some embodiments, the virtual SIM uses the identification of the physical SIM, allowing the virtual SIM to carry the same phone number as the physical SIM.

In operation 520, the user can optionally have internet or wifi network connectivity with the service provider to perform telecommunication by the internet. The internet communication can occur in home country or in a foreign country. In operation 530, when the user is within the network coverage of a telephone company, for example, a partner telephone company of the service provider, the virtual SIM can identify the mobile phone as a registered user, and can be used to perform communication service, such as voice calls or text messages.

The user can select foreign coverage, meaning that the mobile phone can be used in a particular foreign country. The user can select home coverage, meaning the mobile phone can be used in the home country of the user.

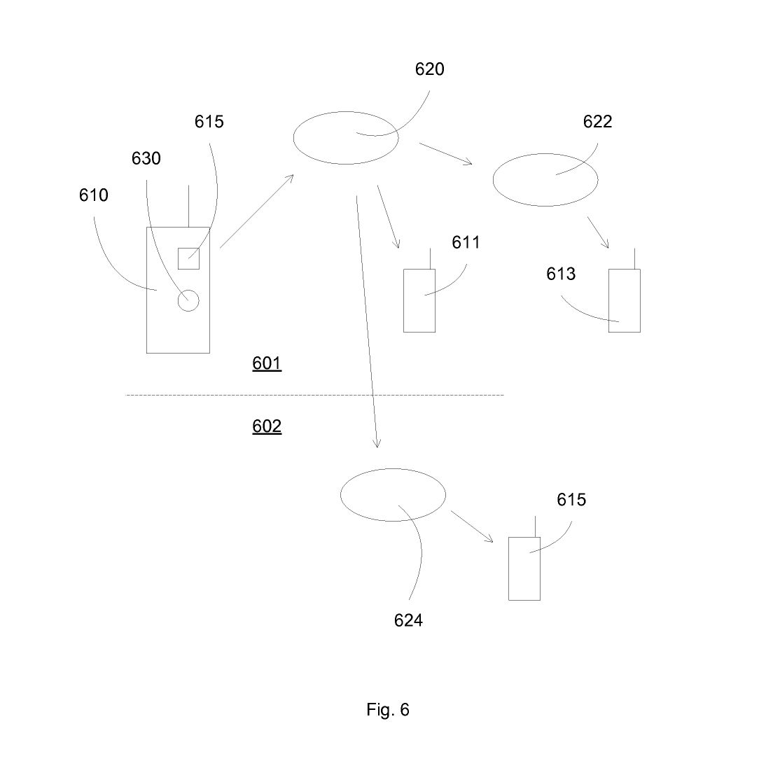

FIG. 6 illustrates communication paths originated from a physical SIM according to some embodiments. A mobile phone 610 can have a physical SIM 615, which can establish communication with a telephone company 620 in country 601. The country 601 can be a home country with regard to the mobile phone 610. When the mobile phone wants to connect with another phone, e.g., phone 611, 613 or 615, the mobile phone 610 can communicate with the network 620. If the recipient phone 611 is also within the network 620, the network 620 can connect the phone 611 with the mobile phone 610, for a voice call or a text message transmission. If the recipient phone 611 is within the country 601 but from another network 622, the network 620 can communicate with the other network 622, which then can connect the phone 613 with the mobile phone 610, for a voice call or a text message transmission. If the recipient phone 615 is outside the country 601, for example, in another country 602, the network 620 can communicate with the network 624 in country 602, which then can connect the phone 615 with the mobile phone 610, for a voice call or a text message transmission.

A mobile phone can have virtual SIM 630 connectivity in a foreign country. The service provider can keep an up-to-date database of partners (e.g., one per country) within the application on the mobile phone. For example, after the mobile phone is turned on in a foreign country, the partner company can pick up SIM IMSI number, look up in VLR roaming database and acquire authorization from VSSP to provide service to this virtual SIM user, such as data and voice service.

In some embodiments, the telephone number appears at the recipient can be the phone number of the physical SIM. For example, when the mobile phone is at a home country, the appeared number for a home recipient can be the local number, e.g., without the home country code. The appeared number for a foreign recipient can be the complete number, e.g., the local number plus the home country code. When the mobile phone is at a foreign country, the appeared number for a foreign recipient can be the complete number, e.g., with the country code. The appeared number for a home recipient can be the local number or the complete number, e.g., the local number plus the foreign country code.

In some embodiments, a user, when signed up with a service provider, can be provided with a telephone number. This telephone number can be used to identify the mobile phone when the service provider wants to communicate with the user. In some embodiments, the provided telephone number can be a number generated by the service provider. Thus a return call can connect to the service provider and the service provider can forward the communication to the mobile phone. The service provider can locate the mobile phone, for example, by checking the partners to see if the mobile phone is within the coverage network of any partner, and then forward the communication to the partner network to be sent to the mobile phone. The service provider can receive the call from the first telephone company that owns the physical SIM.

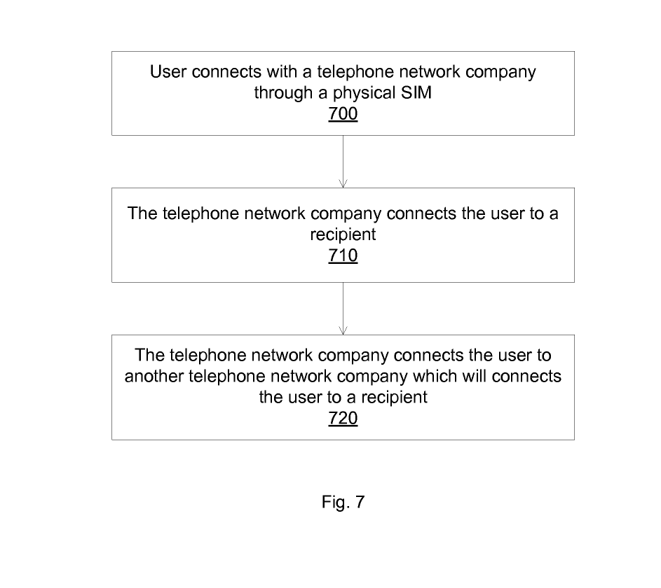

FIG. 7 illustrates a process for connecting a mobile phone to a recipient through a physical SIM according to some embodiments. A user can sign up with a first telephone company, which then provides a physical SIM, and/or a mobile device. The user can be provided with a telephone number to identify the mobile phone of the user.

In operation 700, the user connects with the first telephone network company through the physical SIM. The physical SIM can establish connection with the telephone network company, and thus the mobile phone can have communication with other devices through the telephone network company. In operation 710, after the user initiates a communication, the telephone network company can connect the user with the recipient. In operation 720, if the recipient is not within the telephone network company, the telephone network company can connect the user to another telephone network company, which then will connect the user to the recipient.

In some embodiments, the communication can be performed only within the coverage area of the telephone company to avoid roaming charges. When the user, e.g., the mobile device, is outside the coverage area, the telephone company of the physical SIM is not used. Instead, another telephone company, which is local to the mobile device, can be selected to perform the communication.

In some embodiments, the present invention discloses methods and systems to convert roaming communication to local communication. Using a virtual SIM and a physical SIM that can be recognized by multiple telephone networks in multiple countries, a mobile phone having the virtual SIM can enjoy local access, either by initiate or by receiving the communication. For example, in a home country, the mobile phone can be connected to a home telephone network through the physical SIM, thus becoming a local client in the home country. In a foreign country, the mobile phone can be connected to a foreign telephone network through the virtual SIM, thus becoming a local client in the foreign country. The distance of communication, e.g., the distance between the mobile phone and a recipient, can be a physical distance, e.g., the actual distance between the mobile phone and the recipient, and not the distance that the signal has to travel, e.g., signals from a recipient from a foreign country to the home country then back to the foreign country to reach the mobile phone when both the recipient and the mobile phone are at the foreign country.

The connectivity of the virtual SIM to multiple telephone networks can be facilitated by a service provider. The user of a mobile phone thus can have a central location of service, for example, for customer service, billings, and dealing with foreign telephone networks. After accepting the service of a service provider, the user can select multiple foreign countries to have communication access. The mobile phone then can be recognized by multiple telephone networks in multiple countries, and the user can enjoy local access and local charges when traveling to these foreign countries. A further benefit can be that the user in a foreign country can still have the same identification, e.g., phone number.

In some embodiments, a mobile phone can send an SMS or call to an arbitrary phone number. The virtual SIM can connect to a telephone server, and send the SMS or establish a voice connectivity between the mobile phone and the recipient. For example, the virtual SIM can send the SMS and the recipient telephone number to the telephone company server. The telephone company can then use its standard gateway to forward the SMS to the recipient mobile number. The cost can be lower for the mobile phone user. For international connectivity, the virtual SIM can connect directly with the telephone company in the foreign country and the process flow can be similar.

In some embodiments, instead of using the standard telephone gateway, the telephone partner can forward the SMS or voice connectivity to the mobile phone using the server of the service provider.

In some embodiments, the virtual SIM, acquired from the service provider, can turn the mobile phone into a customer for the telephone partner of the service provider.

In some embodiments, the virtual SIM can have the telephone number of the physical SIM. The country code and/or city code can be added to the common local number to form a complete telephone number. Thus a same telephone number can be used by the mobile phone in multiple countries. For call or text initiated from a foreign country, e.g., a country that is far from the country that the mobile phone is currently located, a forwarding telephone number can be needed for reaching the mobile phone, e.g., through the service provider. The forwarding service can be performed by the home network to the service provider, after the service provider locates the mobile phone, e.g., in which country and/or city that the user is located.

In some embodiments, the service provider can keep track of the location of the mobile phone. For example, when the mobile phone is turned on in a foreign country, the foreign telephone network can recognized and provide access to the mobile phone. At the same time, the foreign network can notify the service provider of the mobile phone location. The service provider then can contact the home network to forward any communication to the mobile phone, from the home country, to the foreign country.

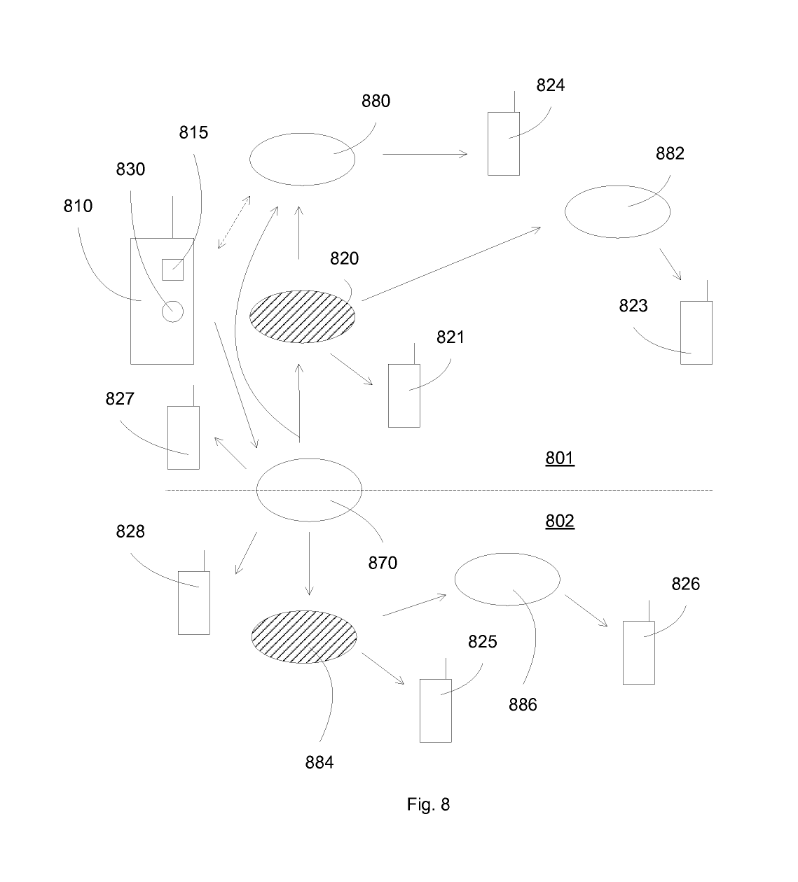

FIG. 8 illustrates a configuration for communication transmission to a virtual SIM/physical SIM combination in a home country according to some embodiments. A telephone number from the physical SIM 815 can be acquired by the virtual SIM 830, which can identify the mobile phone 810. For example, the mobile phone 810 can have a service agreement with the telephone company 880, which provides the physical SIM 815.

The mobile phone 810 can sign up with a service provider 870, which can have multiple telephone partners 820 and 824. The service provider 870 can include a server which can reached by internet connection.

When the mobile phone 810 is in home country 801, the mobile phone 810 can communicate with the service provider 870, for example, through internet connection. Direct internet connection can be established for other users 827 in home country 801 or other users 828 in foreign country 802.

The mobile phone 810 can communicate with other mobile phones 824 through the first telephone company 880, after passing through the service provider 870.

The mobile phone 810 can communicate with other mobile phones 824 through telephone partners 820, 884 of the service providers. For example, a home mobile phone 821 can be communicated through the telephone partner 820. A foreign mobile phone 825 can be communicated through the telephone partner 884. Alternatively, the partners 820 and 884 can connect to other telephone companies to reach the recipient. For example, a home mobile phone 823 can be communicated through the telephone partner 820 to the telephone company 882. A foreign mobile phone 826 can be communicated through the telephone partner 884 to the telephone company 886.

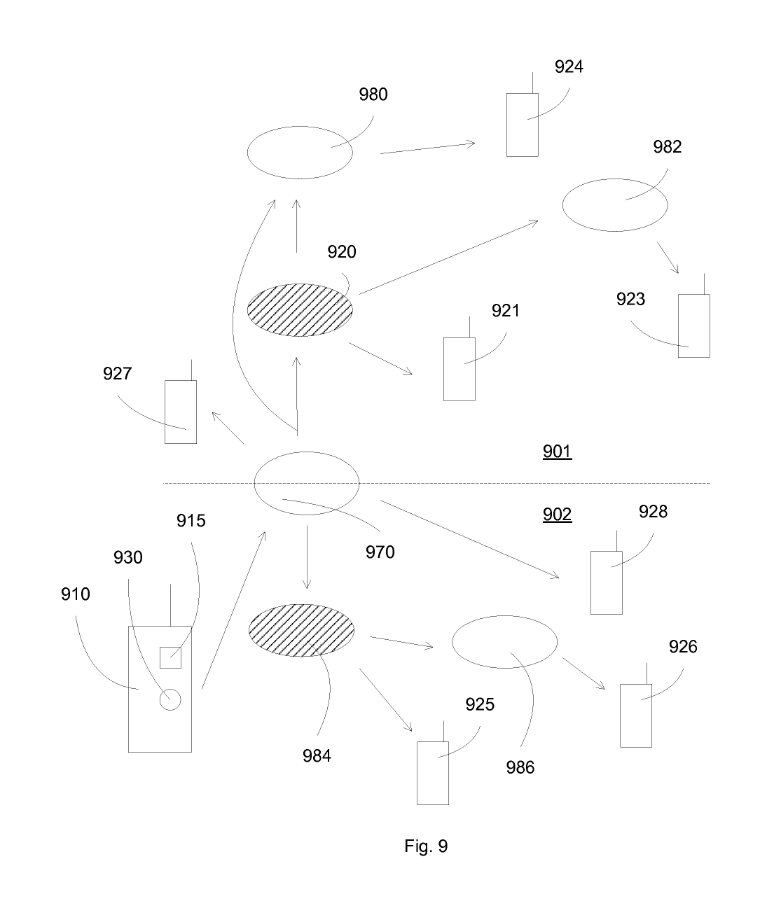

FIG. 9 illustrates a configuration for communication transmission to a virtual SIM/physical SIM combination in a foreign country according to some embodiments. A telephone number from the physical SIM 915 can be acquired by the virtual SIM 930, which can identify the mobile phone 910. For example, the mobile phone 910 can have a service agreement with the telephone company 980, which provides the physical SIM 915.

The mobile phone 910 can sign up with a service provider 970, which can have multiple telephone partners 920 and 924. The service provider 970 can include a server which can reached by internet connection.

When the mobile phone 910 is in foreign country 901, the mobile phone 910 can communicate with the service provider 970, for example, through internet connection. Direct internet connection can be established for other users 927 in home country 901 or other users 928 in foreign country 902.

The mobile phone 910 can communicate with other mobile phones 924 through the first telephone company 980, after passing through the service provider 970.

The mobile phone 910 can communicate with other mobile phones 924 through telephone partners 920, 984 of the service providers. For example, a home mobile phone 921 can be communicated through the telephone partner 920. A foreign mobile phone 925 can be communicated through the telephone partner 984. Alternatively, the partners 920 and 984 can connect to other telephone companies to reach the recipient. For example, a home mobile phone 923 can be communicated through the telephone partner 920 to the telephone company 982. A foreign mobile phone 926 can be communicated through the telephone partner 984 to the telephone company 986.

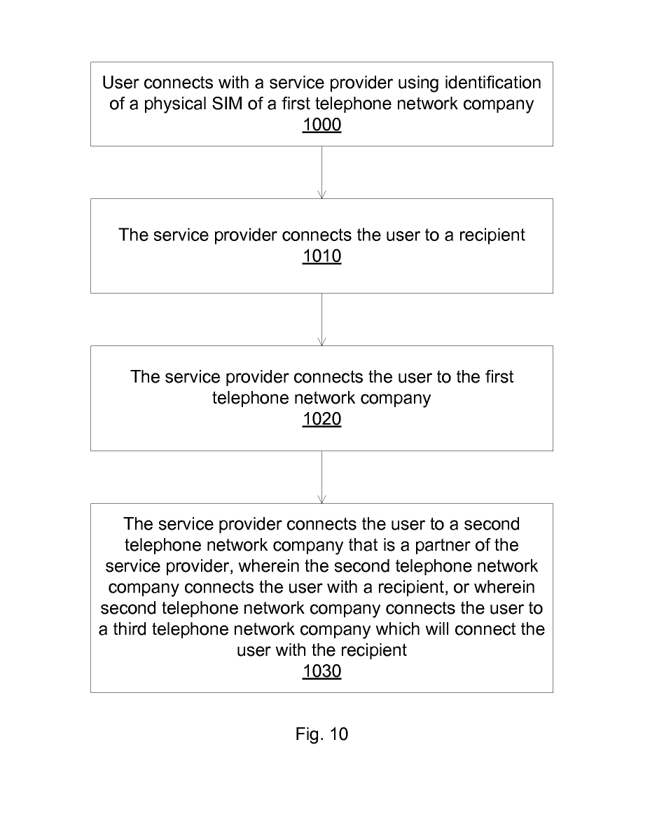

FIG. 10 illustrates a process for connecting a mobile phone to a recipient through a service provider according to some embodiments. A user can sign up with a first telephone company, which then provides a physical SIM, and/or a mobile device. The user can be provided with a telephone number to identify the mobile phone of the user.

In operation 1000, the user connects with a service provider using the identification of the physical SIM. In operation 1010, the service provider can establish connection with a recipient, who also has a service agreement with the service provider. In operation 1020, after the user initiates a communication, the service provider can connect the user with the first telephone network company, which can connect the user with a recipient, who is also has a service agreement with the first telephone company. In operation 1030, if the recipient is not within the first telephone network company, the service provider can connect the user to a second telephone network company, which is a partner of the service provider. The second telephone network company will connect the user to the recipient. The second telephone network company can also connect the user to a third telephone network company, which can connect to the recipient.

In some embodiments, when the mobile device is out of the home country, the virtual SIM can provide local connection to a second telephone company, different from the first telephone company that provides the physical SIM.

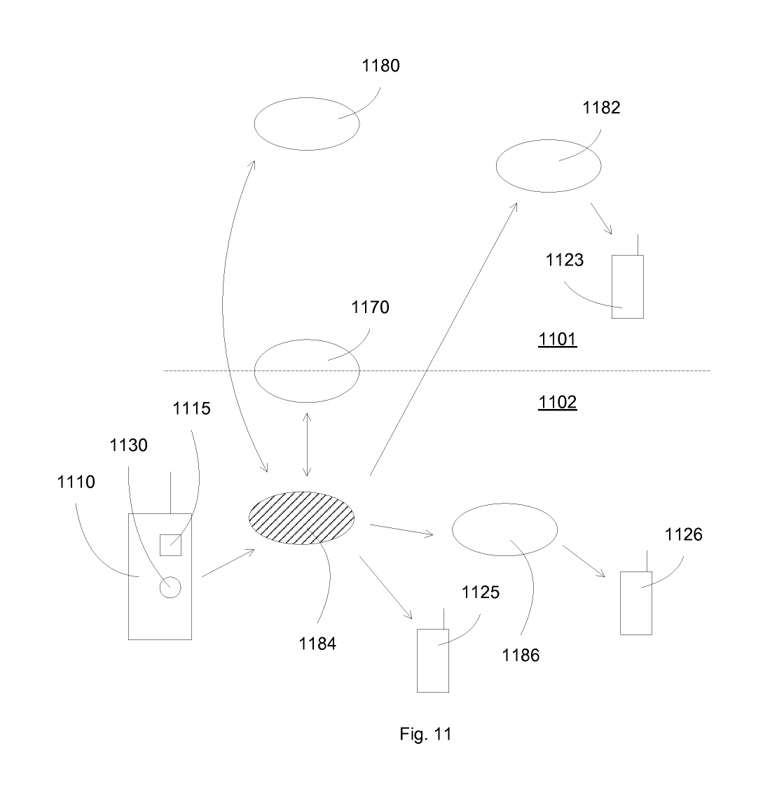

FIG. 11 illustrates a configuration for communication transmission to a virtual SIM/physical SIM combination in a foreign country according to some embodiments. A telephone number from the physical SIM 1115 can be acquired by the virtual SIM 1130, which can identify the mobile phone 1110. For example, the mobile phone 1110 can have a service agreement with the telephone company 1180, which provides the physical SIM 1115.

The mobile phone 1110 can sign up with a service provider 1170, which can have multiple telephone partners 1120 and 1124. The service provider 1170 can include a server which can reached by internet connection.

When the mobile phone 1110 is in foreign country 1102, the mobile phone 1110 can communicate with the telephone company 1184 since the mobile phone 1110 is within a local coverage of the telephone company 1184. For example, after the mobile phone 1110 is turned on, a IMSI can be broadcasted. The signal can be picked up by the telephone company 1184, since the mobile phone 1110 is within the local service area. The telephone company 1184 can contact the service provider 1170, to establish that the mobile phone 1110 is authorized to use the service. Information from the virtual SIM and the physical SIM can be provided to the service provider. The telephone company 1184 can also contact the first telephone company 1180, for example, to have permission to establish a connection with the mobile phone 1110. Information from the physical SIM can be provided to the first telephone company.

After getting the authorization, the telephone company 1184 can provide local communication coverage to the mobile phone 1110. For example, mobile phone 1110 can have a local call with other users 1125, 1126 in the foreign country 1102 or other users 1123 in foreign country 1102. User 1125 can be connected through the telephone company 1184, while user 1126 can be connected through an additional telephone company 1186. Connection to user 1123 can be a long distance call, through the telephone company 1182 in the home country 1101. In all cases, the calls are not subjected to roaming charges.

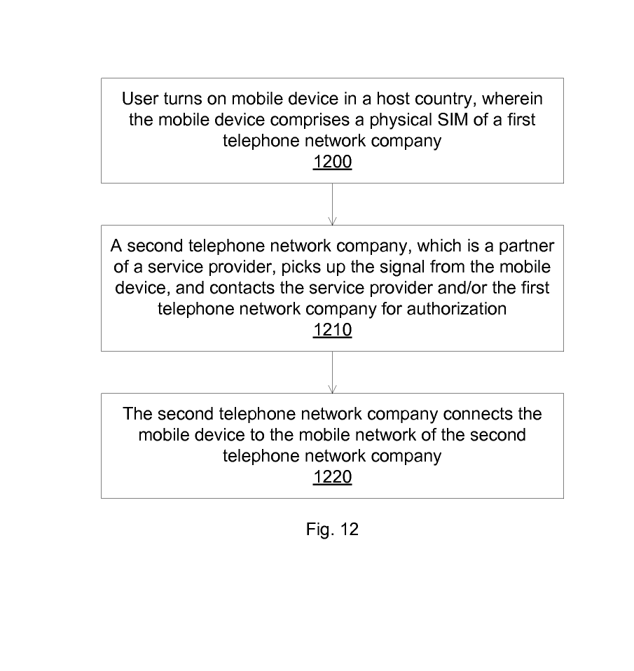

FIG. 12 illustrates a process for connecting a mobile phone to a recipient through a foreign telephone company according to some embodiments. A user can sign up with a first telephone company, which then provides a physical SIM, and/or a mobile device. The user can be provided with a telephone number to identify the mobile phone of the user.

In operation 1200, the user turns on the mobile device in a foreign country. Identification from the physical SIM can be broadcasted. In operation 1210, a foreign telephone company, e.g., local to the current position of the user but foreign to the home country of the user, can picks up the signal from the mobile device, and contacts the service provider and/or the first telephone network company for authorization. In operation 1220, after receiving authorization, the foreign telephone company connects the mobile device to the mobile network of the foreign telephone network company. Any calls made from the mobile device can be a local call, using the telephone number from the physical SIM, e.g., original telephone number of the mobile device as in the home country.

In some embodiments, the service provider can provide a telephone number to the user. The telephone number can be used by the service provider to forward communication that a recipient intended to send to the user.

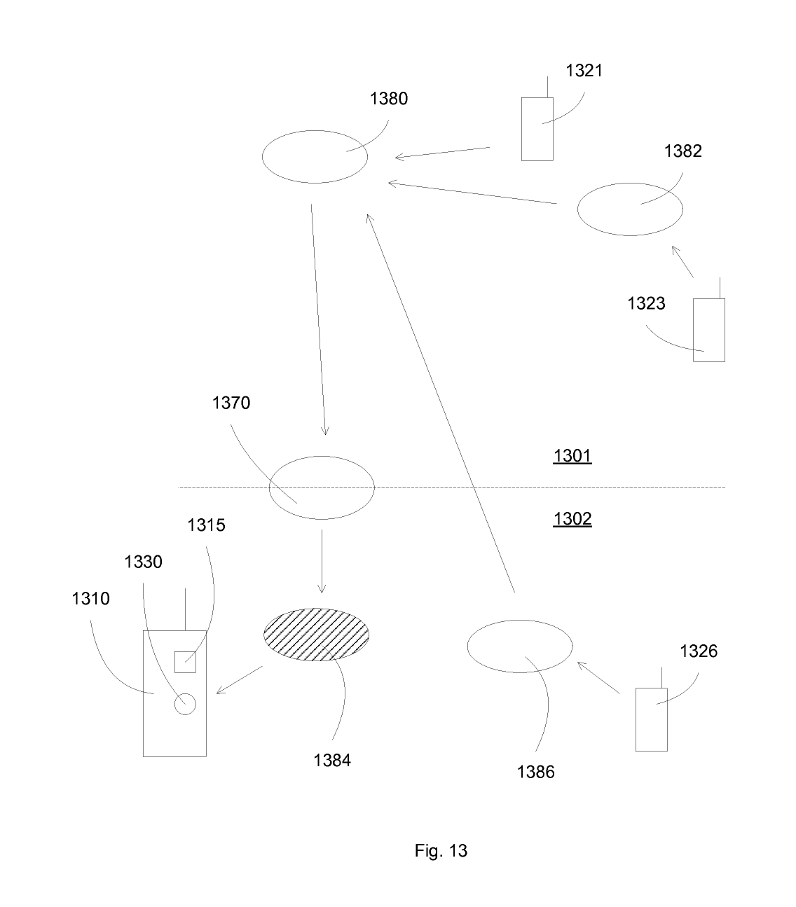

FIG. 13 illustrates another configuration for communication transmission to a virtual SIM according to some embodiments of the present invention. A telephone number can be assigned to the virtual SIM 1330, which can identify the mobile phone 1310 to the service provider. The telephone number can be provided by a service provider when a user signs up for mobile phone service. The telephone number can be a forwarding telephone number, which is different from an original telephone number, e.g., the telephone number that identifies the mobile device to other mobile devices, assigned with the physical SIM 1315.

When the mobile phone is in the home country 1001, all received calls can reach the first telephone company 1380, which then connects the calls to the mobile device 1310. When the mobile phone 1310 is in foreign country 1302, all received call will also first reach the first telephone company 1380. For example, the received calls can be from user 1321 who shares the same first telephone network company. The received calls can be from user 1323, which passes through telephone network 1382 before reaching the first telephone network company 1380. The received calls can be from user 1326 from a foreign country, which passes through telephone network 1386 before reaching the first telephone network company 1380.

The service provider 1370 can receive the calls from the first telephone company 1380. For example, the first telephone company 1380 can forward the received calls only after not being able to reach the mobile device. The first telephone company 1380 can forward the received calls regardless of the mobile device.

The service provider then can locate the mobile device 1310 to pass the calls. The service provider can query the telephone partners to locate the mobile device 1310, for example, by asking if any telephone partner is currently providing connection to the mobile device. After identifying the telephone company, the service provider can forward the calls to the second telephone company, which can forward the calls to the mobile device. The forwarding number can be used to identify the mobile device, for example, by associating the forwarding number with the mobile device identification so that the second telephone company can forward the calls to the correctly user.

In some embodiments, the forwarding number can be the telephone number assigned by the physical SIM, e.g., the original telephone number of the mobile device. Since the mobile device uses the original telephone number (e.g., from the physical SIM) to establish connection with the foreign telephone company, the mobile device can be identified by the original telephone number, at least by the foreign telephone company.

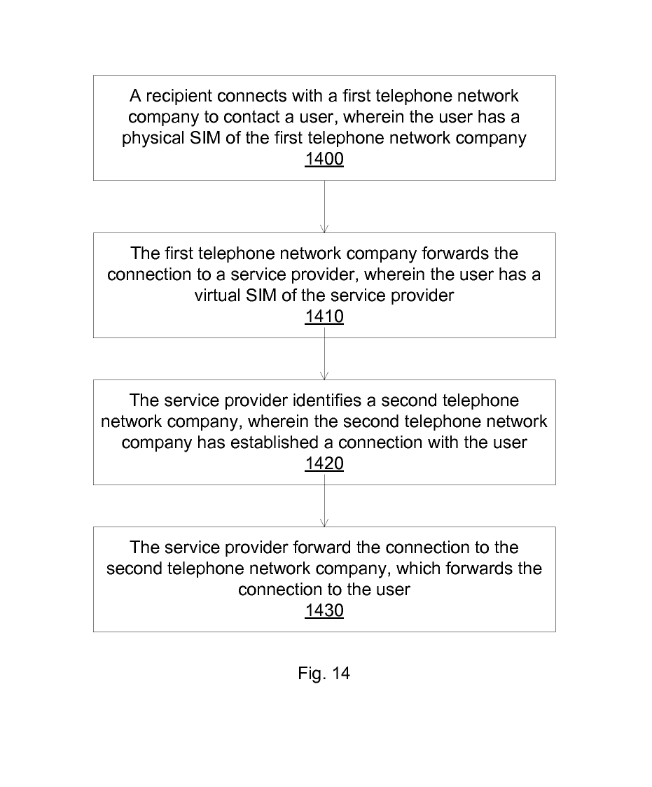

FIG. 14 illustrates another process for connecting a mobile phone to a recipient according to some embodiments. A user can sign up with a service provider. The user can be provided with a telephone number to identify a mobile phone of the user among the partners of the service provider.

In operation 1400, a recipient connects with a first telephone network company to contact a user, wherein the user has a physical SIM of the first telephone network company. In operation 1410, the first telephone network company forwards the connection to a service provider, wherein the user has a virtual SIM of the service provider. In operation 1420, the service provider identifies a second telephone network company, wherein the second telephone network company has established a connection with the user. In operation 1430, the service provider forward the connection to the second telephone network company, which forwards the connection to the user.

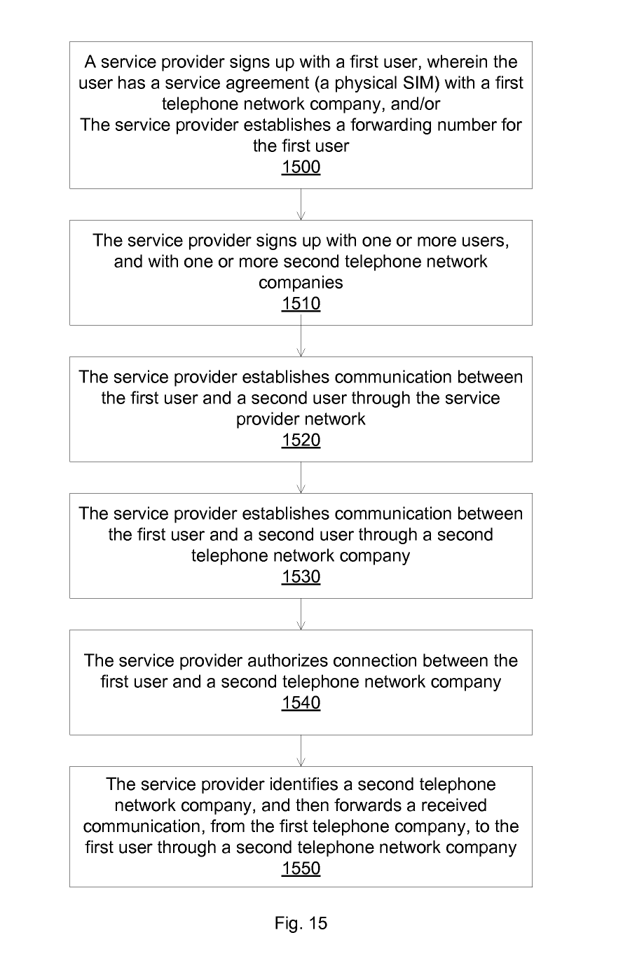

FIG. 15 illustrates a process for a service provider according to some embodiments. In operation 1500, a service provider signs up with a first user, wherein the user has a service agreement (a physical SIM) with a first telephone network company, and/or the service provider establishes a forwarding number for the first user. In operation 1510, the service provider signs up with one or more users, and with one or more second telephone network companies. In operation 1520, the service provider establishes communication between the first user and a second user through the service provider network. In operation 1530, the service provider establishes communication between the first user and a second user through a second telephone network company. In operation 1540, the service provider authorizes connection between the first user and a second telephone network company. In operation 1550, the service provider identifies a second telephone network company, and then forwards a received communication, from the first telephone company, to the first user through a second telephone network company.

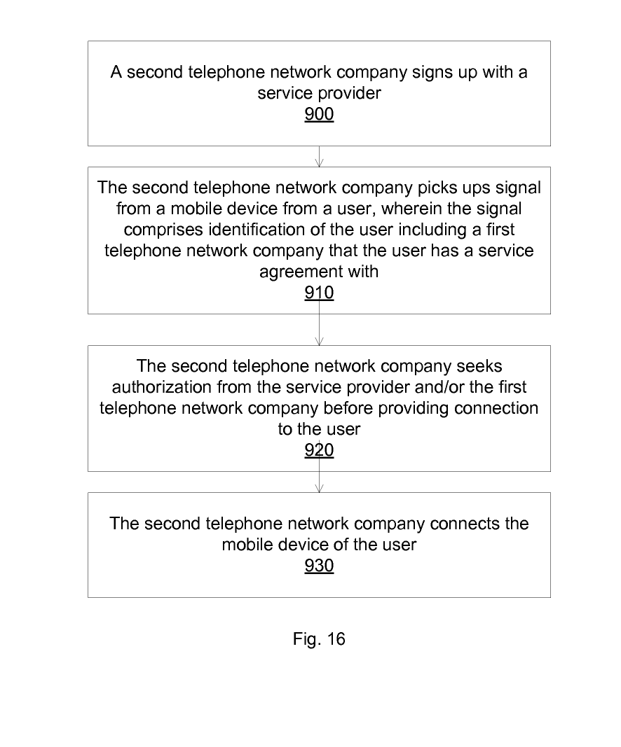

FIG. 16 illustrates a process for a foreign telephone company to establish a connection with a virtual SIM according to some embodiments. In operation 1600, a second telephone network company signs up with a service provider. In operation 1610 the second telephone network company picks ups signal from a mobile device from a user, wherein the signal comprises identification of the user including a first telephone network company that the user has a service agreement with. In operation 1620, the second telephone network company seeks authorization from the service provider and/or the first telephone network company before providing connection to the user. In operation 1630, the second telephone network company connects the mobile device of the user.

In some embodiments, provided is a machine readable storage, having stored thereon a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, e.g. a processor.

In some embodiments, the methods can be realized in hardware, software, or a combination of hardware and software. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

The terms “computer program”, “software”, “application”, variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

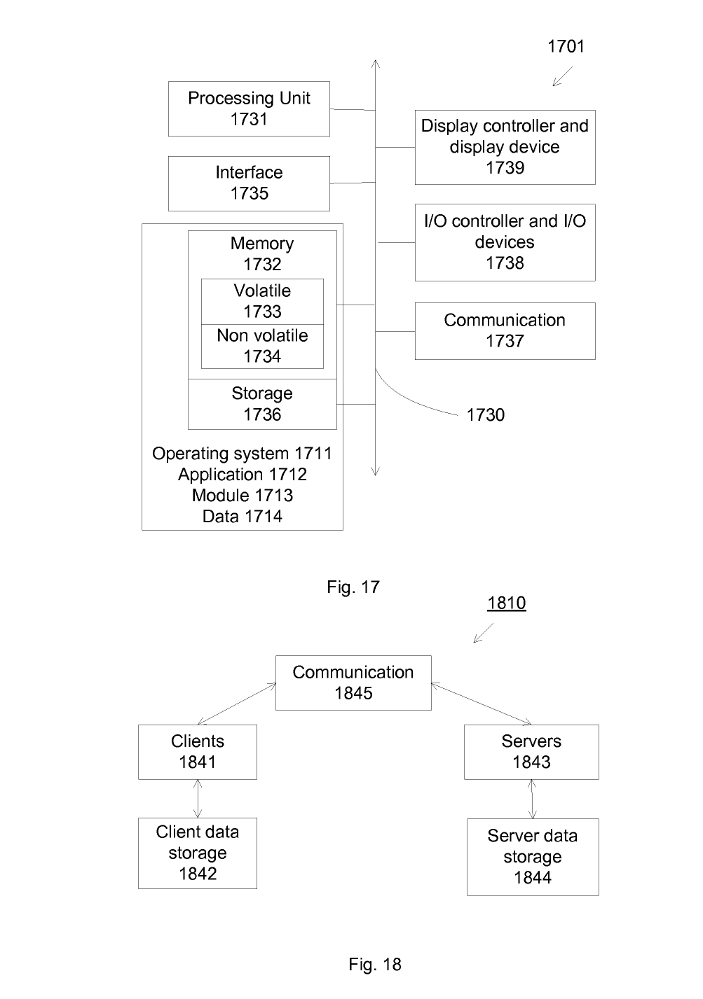

FIG. 17 illustrates a computing environment according to some embodiments. An exemplary environment 1700 for implementing various aspects of the invention includes a computer 1701, comprising a processing unit 1731, a system memory 1732, and a system bus 1730. The processing unit 1731 can be any of various available processors, such as single microprocessor, dual microprocessors or other multiprocessor architectures. The system bus 1730 can be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1732 can include volatile memory 1733 and nonvolatile memory 1734. Nonvolatile memory 1734 can include read only memory (ROM), programmable ROM (PROM), electrically programmable ROM (EPROM), electrically erasable ROM (EEPROM), or flash memory. Volatile memory 1733, can include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

Computer 1701 also includes storage media 1736, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1735 can be used to facilitate connection.

The computer system 1701 further can include software to operate in environment 1700, such as an operating system 1711, system applications 1712, program modules 1713 and program data 1714, which are stored either in system memory 1732 or on disk storage 1736. Various operating systems or combinations of operating systems can be used.

Input devices 1722 can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1738. Interface ports 1738 can include a serial port, a parallel port, a game port, a universal serial bus (USB), and a 1394 bus. The interface ports 1738 can also accommodate output devices 1721. For example, a USB port may be used to provide input to computer 1701 and to output information from computer 1701 to an output device 1721. Output adapter 1739, such as video or sound cards, is provided to connect to some output devices such as monitors, speakers, and printers.

Computer 1701 can operate in a networked environment with remote computers 1724. The remote computers 1724, shown with a memory storage device 1725, can be a personal computer, a server, a router, a network PC, a workstation, a microprocessor based appliance, a peer device or other common network node and the like, and typically includes many or all of the elements described relative to computer 1701. Remote computers 1724 can be connected to computer 1701 through a network interface 1723 and communication connection 1737, with wire or wireless connections. Network interface 1723 can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

FIG. 18 is a schematic block diagram of a sample computing environment 1800 with which the present invention can interact. The system 1840 includes a plurality of client systems 1841. The system 1840 also includes a plurality of servers 1843. The servers 1843 can be used to employ the present invention. The system 1840 includes a communication network 1845 to facilitate communications between the clients 1841 and the servers 1843. Client data storage 1842, connected to client system 1841, can store information locally. Similarly, the server 1843 can include server data storages 1844.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A virtual SIM for use in a mobile communication device, the virtual SIM comprising
a first module for communicating with a first telephone company through a physical SIM;
a second module for communicating with a service provider;
a third module for communicating with one or more second telephone companies, wherein the one or more second telephone companies have a service agreement with the service provider;
a fourth module for assessing a connectivity of the mobile communication device with the first or the one or more second telephone companies.

2. A virtual SIM as in claim 1, wherein the first module is configured to enable communication through the first telephone company through the physical SIM.

3. A virtual SIM as in claim 1, wherein the second module is configured to accept a forwarding telephone number for communication with the service provider.

4. A virtual SIM as in claim 1, wherein the second module is configured to accept a service contract with the service provider.

5. A virtual SIM as in claim 1, wherein the third module is configured to enable communication with a second telephone company of the one or more second telephone companies using a mobile device identification of the physical SIM.

6. A virtual SIM as in claim 1, wherein the fourth module is configured to identify a location of the mobile communication device.

7. A mobile communication device comprising
a physical SIM for communicating with a first telephone company;
a virtual SIM for communicating with one or more second telephone companies through a service provider agreement,
wherein the virtual SIM uses a mobile device identification of the physical SIM in establishing communication with the one or more second telephone companies.

8. A mobile communication device as in claim 7, wherein the physical SIM comprises a telephone number, representing a service contract of the mobile communication device with the first telephone company.

9. A mobile communication device as in claim 7, wherein information related to the physical SIM is transmitted when using the virtual SIM through the second telephone company.

10. A mobile communication device as in claim 7, wherein a telephone number from the physical SIM is transmitted when using the virtual SIM through the second telephone company.

11. A mobile communication device as in claim 7, wherein the virtual SIM comprises a forwarding number for receiving communication from the service provider that is forwarded from the first telephone company.

12. A method for communication using a mobile communication device, the method comprising
communicating with a second mobile communication device through a first telephone company using a physical SIM when the mobile communication device is within a service range of the first telephone company,
communicating with a third mobile communication device through a second telephone company using a virtual SIM when the mobile communication device is within a service range of the second telephone company,
wherein the virtual SIM uses a mobile device identification of the physical SIM in establishing communication with the second telephone company.

13. A method as in claim 12, wherein the physical SIM comprises a telephone number, representing a service contract of the mobile communication device with the first telephone company.

14. A method as in claim 12, wherein information related to the physical SIM is transmitted to the third mobile communication device when using the virtual SIM through the second telephone company.

15. A method as in claim 12, wherein a telephone number from the physical SIM is transmitted to the third mobile communication device when using the virtual SIM through the second telephone company.

16. A method as in claim 12, wherein the communication with the third mobile communication device is a local communication without incurring roaming charges.

17. A method as in claim 12, wherein communicating through a second telephone company comprises
picking up, by the second telephone company, an identification from the physical SIM;
acquiring authorization, by the second telephone company, from a service provider;
providing communication service to the mobile communication device.

18. A method as in claim 12, wherein communicating through a second telephone company comprises
receiving, by a service provider, a communication from the third communication device through the first telephone company;
identifying, by the service provider, the second telephone company providing service to the mobile communication device;
forwarding the communication, by a service provider, to the second telephone company for connecting with the mobile communication device.

19. A method as in claim 12, wherein the communication comprises a message according to an SMS format.

20. A method as in claim 12, wherein the communication is performed via a GPRS (general packet radio service) connection, 2G, 3G, or 4G (generation of mobile telecommunication), or wifi connection.
